(19) United States
(12) Patent Application Publication
(10) Pub. No.: US 2010/0291845 A1
(43) Pub. Date: Nov. 18, 2010

(54) DIAMOND TOOL

(75) Inventors: Hyun Woo Lee, Incheon (KR); Jong Hwan Park, Seoul (KR); Seo Bong Byun, Incheon (KR); Kang Sun Lee, Gunpo-si (KR)

Correspondence Address: SEED INTELLECTUAL PROPERTY LAW GROUP PLLC, 701 FIFTH AVE, SUITE 5400, SEATTLE, WA, 98104, US

(73) Assignee: SHINHAN DIAMOND IND. CO., LTD., Incheon (KR)

(21) Appl. No.: 12/515,274

(22) PCT Filed: Apr. 24, 2007
(86) PCT No.: PCT/KR07/01987

§ 371 Date: Aug. 6, 2010

(30) Foreign Application Priority Data
Nov. 16, 2006 (KR) 10-2006-0113539

(51) Int. Cl. B24D 5/12; B23D 61/02

(52) U.S. Cl. 451/544

(57) ABSTRACT

The present invention relates to a diamond tool for cutting a work-piece. An object of the present invention is to provide a diamond tool, wherein diamond granules are arranged at outer peripheries of segments and on certain circumferences and placed in a radial pattern from a center of a shank of the diamond tool, so that a constant cutting force is maintained even though the segments are worn out, and thus, the same cutting force is maintained during the service life of the diamond tool. A diamond tool according to the present invention for achieving the object comprises a shank in the form of a wheel or disk; segments attached to an outer peripheral surface of the shank; and a plurality of diamond granules that are attached to the segments and arranged at an outer periphery of each of the segments and on a plurality of circumferences spaced apart by a certain distance from one another and are placed in a radial pattern from the center of the shank.

### BACKGROUND

1. Technical Field

The present invention relates to a diamond tool for cutting a work piece, and more particularly, to a diamond tool that always has a constant cutting force even when segments of the diamond tool are worn out as the diamond tool has been used for a long time.

2. Description of the Related Art

FIG. 1 is a plan view showing a typical diamond tool.

As shown in FIG. 1, the diamond tool 10 that is a tool for cutting or grinding a surface of a work piece generally includes a shank 12 that takes the shape of a wheel or disk and is to be coupled to a machining apparatus and segments 14 attached to an outer periphery of the shank 12 to cut a work piece.

Each of the segments 14 comprises a binder 16 in the form of paste and diamond granules 15 irregularly dispersed in the binder 16. A mixture of the binder 16 and the diamond granules 15 are placed in a mold with a predetermined shape and then subjected to heat and pressure so that the mixture can be sintered and dried to manufacture the segment 14.

The aforementioned manufacturing process has an advantage in that the segments 14 can be easily manufactured. However, deviations in the products may occur according to the distributed state of the diamond granules 15 and there may be a case where an insufficient or excessive amount of diamond granules 15 is contained in the binder 16.

Therefore, in order to solve these problems, U.S. Pat. No. 2,194,546 discloses a technique for arranging diamond granules 15 in a certain pattern. When the diamond granules 15 are arranged in a certain pattern as such, overuse of the diamond granules 15 can be prevented, thereby reducing manufacturing costs. Further, the regular arrangement of the diamond granules 15 leads to improvement in the product performance and reduction in the performance deviation, resulting in improved reliability of the products.

As described above, methods of arranging the diamond granules 15 in a certain pattern have been actively attempted since early 1990s, and examples thereof are disclosed in U.S. Pat. Nos. 4,925,457, 5,092,910, 5,049,165 and the like. In these methods, a wire mesh or a network screen in which diamond granules will be arranged regularly is placed on a flexible carrier formed of a thermoplastic binder 16 and metallic fibers or a mixture thereof, and the diamond granules 15 are then forcibly inserted into openings of the wire mesh or network screen.

Meanwhile, there has been recently developed a diamond tool in which diamond particles are arranged in segments 14 in a lattice pattern as disclosed in Korean Patent No. 597,717.

FIGS. 2(a) and (b) show conventional segments for a diamond tool. Such a diamond tool 20 includes segments 24 formed by arranging diamond granules in a lattice pattern using a wire mesh or a perforated plate and fixing the diamond granules using a binder 26. In this diamond tool 20, the diamond granules may be arranged in a certain regular pattern as shown in FIG. 2(a), or in a lattice pattern in which imaginary lines defined by the diamond granules 25 are tilted by a certain angle α as shown in FIG. 2(b). Here, the angle α at which the imaginary lines defined by the diamond granules 25 are tilted is determined according to a tool moving range in consideration of the radius of a machining apparatus.

However, such a conventional diamond tool has problems in that an outer diameter of the diamond tool is changed as segments with diamond granules arranged in a lattice pattern are continuously used, resulting in reduction in a cutting force and increase in a cutting load on the segments. Further, theoretical verification has not been made on the size of cut chips and a cutting load according to the arrangement of the diamond granules. Therefore, there is a need for further considerations and studies on the arrangement of the diamond granules.

### BRIEF SUMMARY

One of the embodiments of the present invention provides a diamond tool having diamond granules arranged at outer peripheries of segments and on certain circumferences and placed in a radial pattern from a center of a shank of the diamond tool, so that a constant cutting force is maintained even though the segments are worn out, and thus, the same cutting force is maintained during the service life of the diamond tool.

According to one embodiment of the present invention for achieving the object, there is provided a diamond tool comprising: a shank in the form of a wheel or disk, segments attached to an outer peripheral surface of the shank, and a plurality of diamond granules that are attached to the segments and arranged at an outer periphery of each of the segments and on a plurality of circumferences spaced apart by a certain distance from one another and are placed in a radial pattern from a center of the shank.

The diamond granules arranged on an identical circumference in the segment may be arranged at regular intervals. In addition, diamond granules arranged on a following circumference in the segment may be arranged at regular intervals between diamond granules arranged on a leading circumference in the segment. Furthermore, the diamond granules in the segment may be arranged such that an area to be cut by the diamond granules arranged on the leading circumference partially overlap with the area to be cut by the diamond granules arranged on the following circumference. At this time, the area to be cut by the diamond granules arranged on the leading circumference may overlap with the area to be cut by the diamond granules arranged on the following circumference at a ratio of 40 to 70%.

### BRIEF DESCRIPTION OF THE SEVERAL VIEWS OF THE DRAWINGS

The above and other objects, features and advantages of the present invention will become apparent from the following description of preferred embodiments given in conjunction with the accompanying drawings, in which:

FIG. 1 is a plan view showing a typical diamond tool;

FIGS. 2(a) and (b) show conventional segments for a diamond tool;

FIG. 3 is a front view of a diamond tool according to one embodiment of the present invention;

FIGS. 4(a) and (b) are enlarged front views of segments for the diamond tool according to one embodiment of the present invention;

FIG. 5 is a view showing a state where a work piece is subjected to machining using the diamond tool according to one embodiment of the present invention;

FIG. 6 is a view schematically showing a state where a single diamond granule cuts the work piece in FIG. 5;

FIG. 7 is a view showing a machining state when the diamond tool is moved in FIG. 5;

FIG. 8 is a view showing a cut chip generated by the diamond tool according to one embodiment of the present invention;

FIG. 9 is a view showing an embodiment in which diamond granules are radially arranged on imaginary lines extending from the center of a shank of the diamond tool;

FIG. 10 is a view showing an embodiment in which diamond granules are arranged in a lattice pattern at regular intervals identical to intervals on an outer circumference of the shank; and

FIGS. 11 and 12 are views showing the arranged states of the diamond granules with specific dimensions.

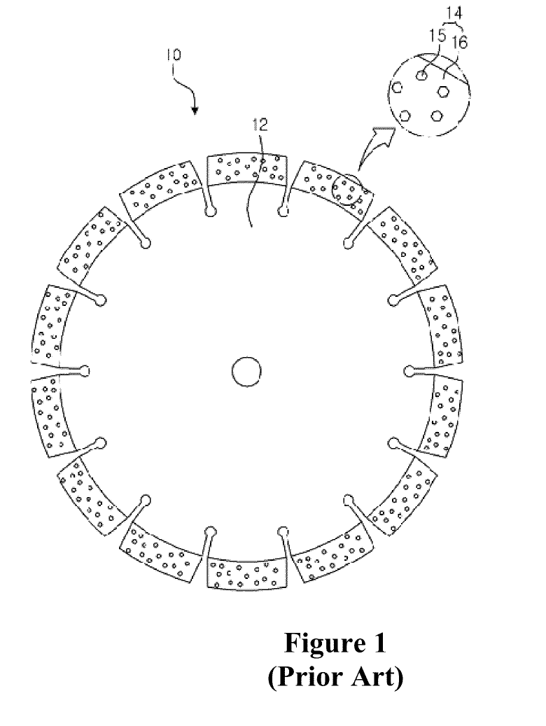

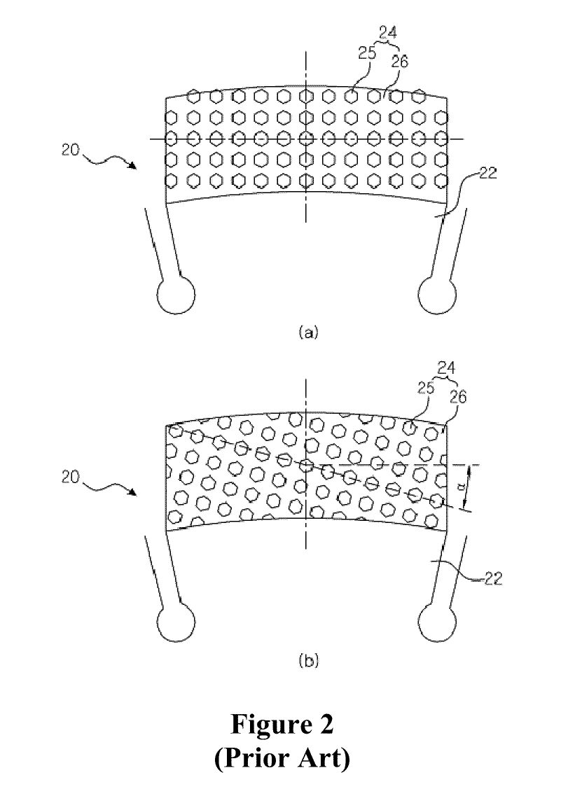

### DETAILED DESCRIPTION

Hereinafter, embodiments of the present invention will be described in detail with reference to the accompanying drawings.

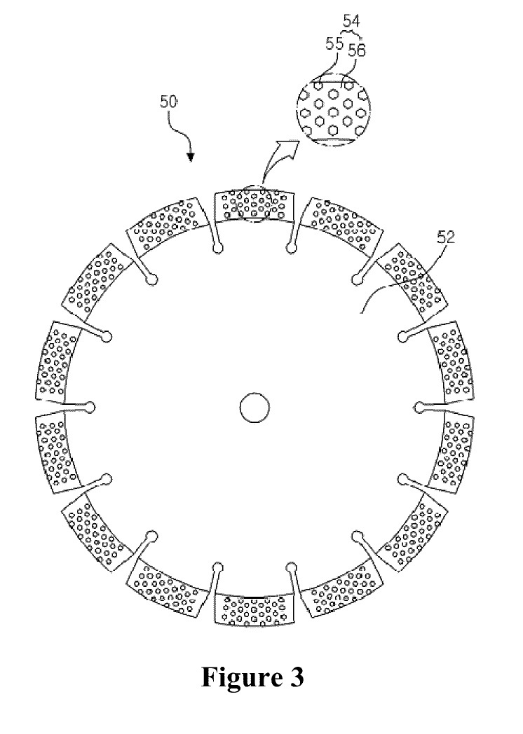

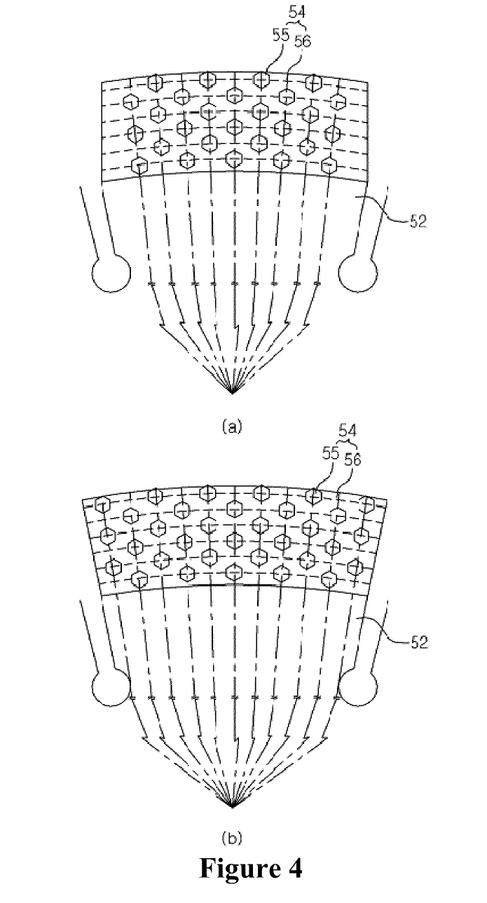

FIG. 3 is a front view of a diamond tool according to one embodiment of the present invention, and FIGS. 4(a) and (b) are enlarged front views of segments for the diamond tool according to one embodiment of the present invention.

As shown in FIGS. 3 and 4, the diamond tool 50 of the present invention includes a shank 52 that takes the shape of a wheel or disk and is to be coupled to a machining apparatus. The shank 52 has slots with a desired length radially formed in an outer peripheral area toward a central shaft of the shank. Each of segments 54 is attached between adjacent ones of the slots. Each of the segments 54 includes a plurality of diamond granules 55 and a bonding portion 56 for fixing the diamond granules 55. At this time, the segments 54 may be fabricated separately from the shank 52 and then attached to the shank 52, or may be formed directly on the surface of the shank 52.

Here, inner peripheries of the segments 54 have the same curvature as an outer periphery of the shank 52. The overall shape defined by the outer periphery is a circular shape like the central shaft of the shank.

In addition, the segment 54 may be formed such that front and rear faces substantially in charge of cutting are in parallel with each other as shown in FIG. 4(a) or have slopes identical with those of lines extending from the slots.

The diamond granules 55 attached to the segment 54 are arranged at an outer periphery of the segment 54 and on a plurality of circumferences spaced apart by a certain distance from one another. Preferably, the diamond granules are arranged at regular intervals.

Furthermore, the diamond granules 55 attached to the segment 54 are arranged in a radial pattern from the center of the shank 52. At this time, the diamond granules 55 arranged on outer circumferences and those arranged on inner circumferences may be arranged on straight lines extending from the center of the shank. Further, the diamond granules 55 arranged on the same circumference are spaced apart by a constant distance from one another.

Preferably, in the segment 54, the diamond granules 55 arranged on a following circumference may be arranged at regular intervals between the diamond granules 55 arranged on a leading circumference.

In addition, an area to be cut by the diamond granules 55 arranged on the leading circumference may partially overlap with an area to be cut by the diamond granules arranged on the following circumference. Since the area to be cut by the diamond granules 55 arranged on the leading circumference partially overlaps with the area to be cut by the diamond granules arranged on the following circumference as described above, cutting can be performed by the following diamond granules 55 even though the leading diamond granules have come off due to use of the diamond tool 50. Further, since the leading and following diamond granules partially overlap with each other, loads exerted on the following diamond granules 55 can be reduced and the following diamond granules 55 can more accurately cut a surface of a work piece.

Preferably, the diamond granules arranged on the leading and following circumferences overlap with each other at a ratio of 40 to 70%.

While the aforementioned diamond tool 50 cuts a work piece, the segment 54 is worn out. This wear of the segment 54 is caused by breakdown of the diamond granules 55, or escape of the diamond granules 55 due to wear of the bonding portion 56.

Meanwhile, an impact capable of breaking the diamond granules 55 varies according to the rotation speed of a machining apparatus and the size of cut chips from a work piece. That is, as the rotation speed of the machining apparatus increases, a colliding speed of the diamond granules 55 against a work piece increases and thus an impact exerted on the diamond granules 55 also increases. Therefore, it can be understood that if the moving speed and cutting depth of the machining apparatus increase to increase the size of cut chips, a cutting load also increases. In a cutting process by the diamond tool 50, the relationship between the size of cut chips and a cutting load fᵣ is expressed as the following formula 1:

fᵣ=kt_{c}ⁿ (1)

where t_{c} is an average size of cut chips, k is a constant, and n is an exponent varying with the type of work piece.

Therefore, it can be seen from formula 1 that the cutting load fᵣ occurring during a cutting process increases in proportion to the size of cut chips t_{c}. Further, considering that the size of cut chips t_{c} is a major factor to affect the cutting load fᵣ, the size of cut chips t_{c} becomes uniform as constant k approaches one (1). Furthermore, as constant k approaches one (1), uniform cutting performance can be maintained.

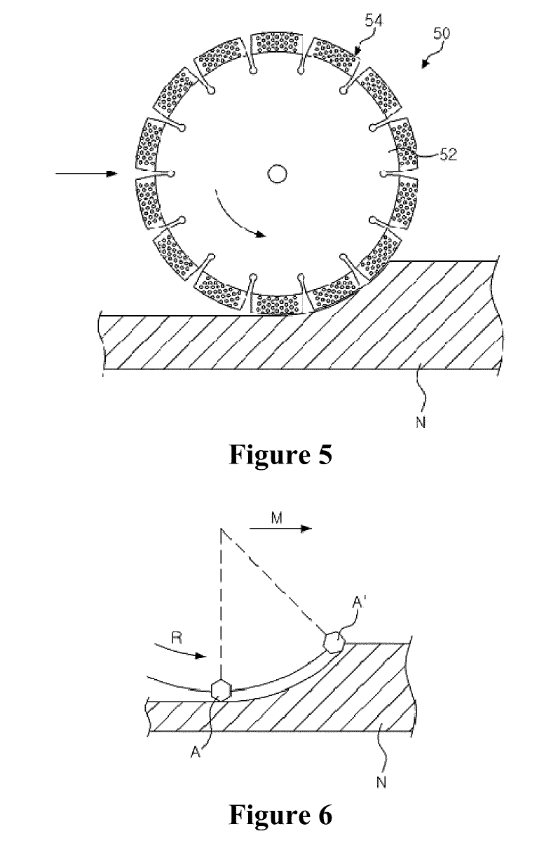

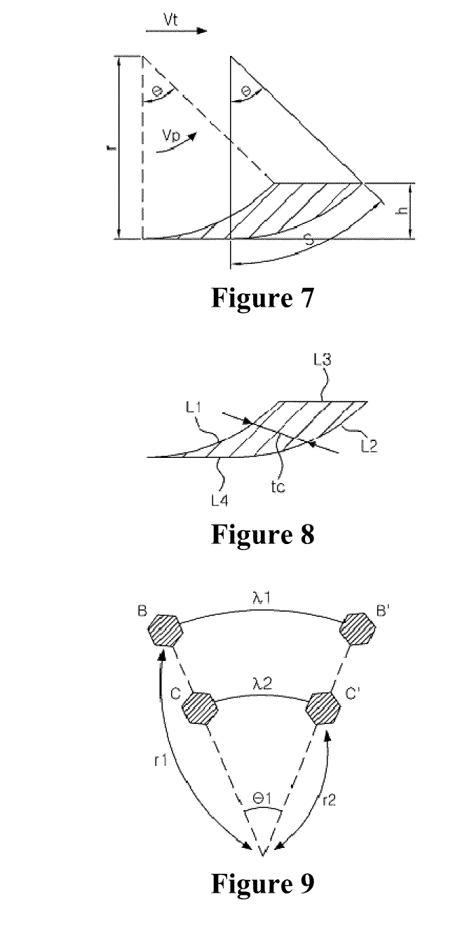

FIG. 5 is a view showing a state where a work piece is subjected to machining using the diamond tool according to the present invention, FIG. 6 is a view schematically showing a state where a single diamond granule cuts the work piece in FIG. 5, FIG. 7 is a view showing a machining state when the diamond tool is moved in FIG. 5, and FIG. 8 is a view showing a cut chip generated by the diamond tool according to the present invention.

Considering a difference in paths of a leading granule A′ and a following granule A in the segment 54 of the diamond tool 50 as a machining apparatus is moved, the amount of cut chips produced by a single diamond granule is shown in FIG. 7. At this time, two lines designate the paths along which the respective granules are moved, and the difference in paths is caused according to the movement of the machining apparatus. Here, M designates a moving direction of the machining apparatus and R designates a rotating direction of the diamond tool 50 coupled to the machining apparatus.

In the cut chip shown in FIG. 8, a line L₁ is a cut line by the leading diamond granule A′ and a line L₂ is a cut line by the following diamond granule A. Lines L₃ and L₄ are cut lines by the movement of the machining apparatus. At this time, it can be seen that the relationship between the line L₁ and line L₂ is a parallel shift as much as the line L₃ or L₄.

In addition, t_{c} is the average size of cut chips, Vₚ is the rotation speed of the cutting tool, λ is the spacing of diamond granules, h is a cutting depth, Vₜ is a moving speed, and S is a cutting length. Considering the foregoing, the average size of cut chips t_{c} can be expressed as the following formula 2:

$${t}_{c} = \frac{λ \cdot {V}_{t}}{{V}_{p}} \sqrt{\frac{h}{2 r}} \vert \qquad ( 2 )$$

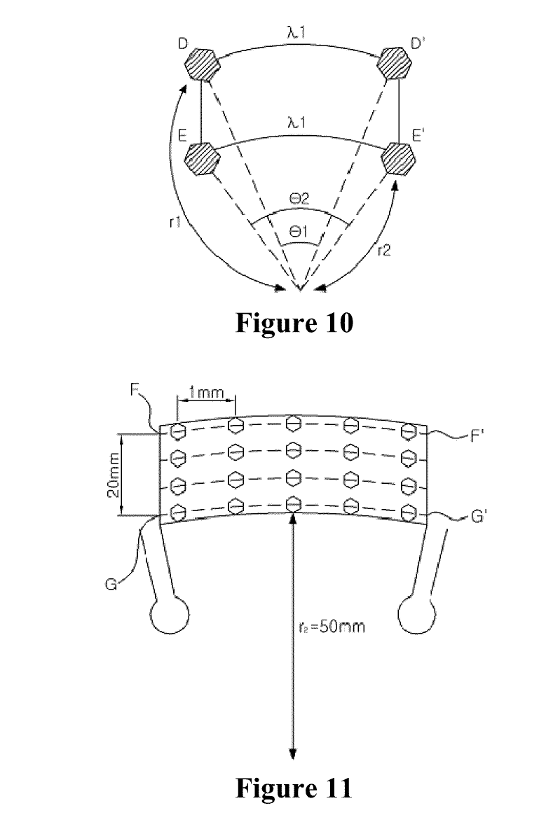

FIG. 9 is a view showing an embodiment in which diamond granules are radially arranged on imaginary lines extending from the center of a shank of the diamond tool, and FIG. 10 is a view showing an embodiment in which diamond granules are arranged in a lattice pattern at regular intervals identical to intervals on an outer circumference of the shank. Here, the radius of arc B-B′ in FIG. 9 is equal to the radius of arc D-D′ in FIG. 10. In addition, the radius of arc C-C′ in FIG. 9 is equal to the radius of arc E-E′ in FIG. 10. Further, the granules arranged on arcs B-B′, D-D′ and E-E′ have a spacing of λ₁. Furthermore, the spacing of the granules arranged on arc C-C′ is λ₂.

When the segments of the diamond tool cut a work piece, cut chips are produced. According to the arranged patterns of the diamond granules 55, the size of cut chips N₁ produced by the cutting tool can be expressed as follows. At this time, all the moving speed and cutting depth of the cutting tool and the rotation speed RPM of the cutting tool (hereinafter, denoted as ‘a’) are the same.

First, putting the size of a chip by arc B-B′ shown in FIG. 9 as t_{c1} and the size of a chip by arc C-C′ as t_{c2}, the sizes of the respective chips are expressed as the following formula 3:

$${t}_{c 1} = \frac{{λ}_{1} \times {V}_{t}}{2 π {r}_{1} \times a} \sqrt{\frac{h}{2 {r}_{1}}} \\ {t}_{c 2} = \frac{{λ}_{2} \times {V}_{t}}{2 π {r}_{1} \times a} \sqrt{\frac{h}{2 {r}_{2}}} \qquad ( 3 )$$

where λ₁ and λ₂ can be computed as

$$2 π {r}_{1} \frac{{θ}_{1}}{360} and 2 π {r}_{2} \frac{{θ}_{1}}{360} \vert ,$$

respectively, since the angles of arcs B-B′ and C-C′ are identical to θ₁.

In the meantime, putting a constant for comparing the sizes of cut chips generated by arcs B-B′ and C-C′ with each other as kₐ, kₐ can be obtained through the following formula 4:

$$\begin{matrix}{t}_{c 1} = \frac{2 π {r}_{1} \times {V}_{t} \times {θ}_{1}}{2 π {r}_{1} \times a \times 360} \sqrt{\frac{h}{2 {r}_{1}}} = \frac{{V}_{t} \times {θ}_{1}}{a \times 360} \sqrt{\frac{h}{2 {r}_{1}}} \\ {t}_{c 2} = \frac{2 π {r}_{2} \times {V}_{t} \times {θ}_{1}}{2 π {r}_{2} \times a \times 360} \sqrt{\frac{h}{2 {r}_{2}}} = \frac{{V}_{t} \times {θ}_{1}}{a \times 360} \sqrt{\frac{h}{2 {r}_{2}}}\end{matrix} \vert \qquad ( 4 )$$

At this time, assuming that t_{c2}=kₐt_{c1},

$${t}_{c 2} = \sqrt{\frac{{r}_{1}}{{r}_{2}}} \cdot {t}_{c 1} \vert .$$

Thus,

$${k}_{a} = \sqrt{\frac{{r}_{1}}{{r}_{2}}} .$$

It can be seen from the foregoing that the size of a cut chip t_{c2} produced by arc C-C′ is kₐ times larger than the size of a cut chip t_{c1} produced by arc B-B′. Thus, as the segment is worn out from arc B-B′ to arc C-C′, a cutting load increases at a ratio of kₐ.

In addition, considering the above formulas, a more uniform cutting load can be maintained if the diamond granules of the segment are arranged in a radial pattern, i.e., if the diamond granules are arranged by determining the spacing of the diamond granules upon arrangement of the diamond granules in a height direction of the segment as the segment is worn out.

Referring to FIG. 10, it is demonstrated that the diamond tool according to the embodiment of the present invention can maintain a uniform cutting load. In FIG. 10, putting the sizes of cut chips by arcs D-D′ and E-E′ as t_{c3} and t_{c4}, respectively, t_{c3} and t_{c4} are expressed as the following formula 5. In addition, a constant for comparing the sizes of cut chips generated by arcs D-D′ and E-E′ with each other is put as k_{b}. Here, the diamond granules arranged on arcs D-D′ and E-E′ have a constant spacing λ₁.

$${t}_{c 3} = \frac{2 {λ}_{1} \times {V}_{t}}{2 π {r}_{1} \times a} \sqrt{\frac{h}{2 {r}_{1}}} \\ {t}_{c 4} = \frac{{λ}_{2} \times {V}_{t}}{2 π {r}_{2} \times a} \sqrt{\frac{h}{2 {r}_{2}}} \qquad ( 5 )$$

At this time, if t_{c4}=k_{b}t_{c3},

$${t}_{c 4} = \frac{{r}_{1}}{{r}_{2}} \sqrt{\frac{{r}_{1}}{{r}_{2}}} \cdot {t}_{c 3} \vert .$$

Thus,

$${k}_{b} = \frac{{r}_{1}}{{r}_{2}} . {k}_{a} \vert .$$

Meanwhile, since r₁/r₂ is larger than one (1), it can be seen from the relationship between a cutting load and the size of a cut chip that the cutting load increases at a lower rate in case of a diamond tool having radially-arranged diamond granules as compared with a diamond tool having lattice-arranged diamond granules.

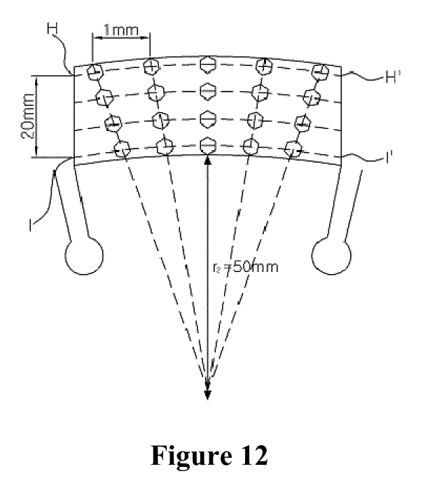

For example, FIGS. 11 and 12 are views showing the arranged states of the diamond granules with specific dimensions. The relationship between a cutting load and the size of a cut chip in diamond granules according to the specific dimensions will be described below with reference to these figures.

Here, as for diamond tools in which a maximum distance between diamond granules of a segment is 20 mm, and the radius of a first circle with the diamond granules arranged thereon, which is nearest to the center of a shank, is 50 mm, machining conditions are set to be identical with each other such that a cutting depth h is 10 mm, a rotation speed RPM is 1000 mm/min, and a moving speed Vₜ is 100 mm/Min. The size of cut chips produced by arcs F-F′ and G-G′ in FIG. 11 and the size of cut chips produced by arcs H-H′ and I-I′ in FIG. 12 are expressed as the following formula 6:

$${t}_{cG} = \frac{70}{50} \sqrt{\frac{70}{50}} \cdot {t}_{cF} \approx 1.65 {t}_{cF} \\ {t}_{cl} = \frac{70}{50} \sqrt{\frac{70}{50}} \cdot {t}_{cM} \approx 1.18 {t}_{cM} \qquad ( 6 )$$

That is, in a case where the diamond granules attached to the segment are arranged in a lattice pattern, the size of cut chips increases at a rate of 65% from an initial cutting-starting point to a final cutting-finishing point. However, in a case where the diamond granules are arranged in a radial pattern, the increasing rate of the size of cut chips is found to be 18%. Thus, the radial arrangement of diamond granules enables manufacture of a diamond tool having a lower increasing rate of a cutting load.

According to the diamond tool of the present invention described above, diamond granules are arranged in consideration of changes in the outer diameter of the diamond tool due to wear of segments, thereby improving cutting performance. Since the diamond granules are arranged at an outer periphery of each of the segments and on certain circumferences and placed in a radial pattern from a center of a shank, a consistent cutting force can be achieved even though the segment is worn out, i.e., a constant cutting force can be maintained during the service life of the diamond tool.

Although the diamond tool of the present invention has been described above with reference to the accompanying drawings, it is not limited to the embodiments descried above and the drawings. It will be apparent to those skilled in the art that various modifications and changes can be made thereto within the scope of the present invention defined by the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheetare incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A diamond tool comprising:
a shank having an outer peripheral region;
a plurality of segments adjacent the outer peripheral region of the shank; and
a plurality of diamond granules attached to the segments and arranged at an outer periphery of each of the segments and on a plurality of circumferences spaced apart by a certain distance from one another, the diamond granules being placed in a radial pattern with respect to a center of the shank.

2. The diamond tool as claimed in claim 1, wherein the diamond granules arranged on an identical circumference in the segment are arranged at regular intervals.

3. The diamond tool as claimed in claim 1, wherein the diamond granules in the segment are arranged such that an area to be cut by diamond granules arranged on a leading circumference partially overlap with an area to be cut by diamond granules arranged on a following circumference.

4. The diamond tool as claimed in claim 3, wherein the area to be cut by the diamond granules arranged on the leading circumference overlap with the area to be cut by the diamond granules arranged on the following circumference at a ratio of 40 to 70%.

5. The diamond tool as claimed in claim 1 wherein the shank is in a form of a wheel or a disk.

6. The diamond tool as claimed in claim 1 wherein the plurality of segments are each fixedly attached to the outer peripheral region.
